(19) United States
(12) Patent Application Publication
(10) Pub. No.: US 2010/0086074 A1
(43) Pub. Date: Apr. 8, 2010

(54) APPARATUS AND METHOD FOR SENSING A MULTI-CARRIER SIGNAL USING CYCLOSTATIONARITY

(76) Inventors: Hou-Shin Chen, Piscataway, NJ (US); Wen Gao, West Windsor, NJ (US)

Correspondence Address: Robert D. Shedd, Patent Operations;THOMSON Licensing LLC, P.O. Box 5312, Princeton, NJ, 08543-5312, US

(21) Appl. No.: 12/449,761

(22) PCT Filed: Jun. 20, 2007
(86) PCT No.: PCT/US2007/014464

§ 371 Date: Aug. 25, 2009

Related U.S. Application Data
(60) Provisional application No. 60/905,691, filed on Mar. 8, 2007.
(60) Provisional application No. 60/919,807, filed on Mar. 23, 2007.
(60) Provisional application No. 60/927,815, filed on May 4, 2007.

(51) Int. Cl. H04L 1/02; H04N 7/173; H04L 27/00

(52) U.S. Cl. 375/267; 725/131; 375/316; 375/316

(57) ABSTRACT

A Wireless Regional Area Network (WRAN) endpoint comprises a transceiver for communicating with a wireless network over one of a number of channels, and a DVB-T (Digital Video Broadcast-Terrestrial) signal detector for use in forming a supported channel list comprising those ones of the number of channels upon which a DVB-T signal was not detected. The WRAN endpoint processes a received signal to provide two data segments and determines an average of the autocorrelation of the two data segments at each one of eight transmission modes for the DVB-T signal. The WRAN endpoint then determines if a DVB-T signal is present as a function of the largest average autocorrelation value.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

A Wireless Regional Area Network (WRAN) system is being studied in the IEEE 802.22 standard group. The WRAN system is intended to make use of unused television (TV) broadcast channels in the TV spectrum, on a non-interfering basis, to address, as a primary objective, rural and remote areas and low population density underserved markets with performance levels similar to those of broadband access technologies serving urban and suburban areas. In addition, the WRAN system may also be able to scale to serve denser population areas where spectrum is available. Since one goal of the WRAN system is not to interfere with TV broadcasts, a critical procedure is to robustly and accurately sense the licensed TV signals that exist in the area served by the WRAN (the WRAN area).

In the United States, the TV spectrum currently comprises ATSC (Advanced Television Systems Committee) broadcast signals that co-exist with NTSC (National Television Systems Committee) broadcast signals. The ATSC broadcast signals are also referred to as digital TV (DTV) signals. Currently, NTSC transmission will cease in 2009 and, at that time, the TV spectrum will comprise only ATSC broadcast signals. However, in some areas of the world, instead of ATSC-based transmission, DVB (Digital Video Broadcasting)-based transmission may be used. For example, DTV signals may be transmitted using DVB-T (Terrestrial) (e.g., see ETSI EN 300 744 V1.4.1 (2001-01), Digital Video Broadcasting (DVB); Framing structure, channel coding and modulation for digital terrestrial television). DVB-T uses a form of a multi-carrier transmission, i.e., DVB-T is OFDM (orthogonal frequency division multiplexing)-based.

Since, as noted above, one goal of the WRAN system is to not interfere with those TV signals that exist in a particular WRAN area, it is important in a WRAN system to be able to detect DVB-T broadcasts (licensed signals) in a very low signal to noise ratio (SNR) environment. For an OFDM signal comprising N sub-carriers with sub-carrier spacing as Fs/N (Hz), its symbols in the time domain can be represented by samples with sample rate Fs (Hz). As known in OFDM transmission, each OFDM symbol includes a cyclic prefix (CP) to mitigate the affects of inter-symbol-interference (ISI). An example of an OFDM symbol 10 is shown in FIG. 1. OFDM symbol 10 comprises two portions: a symbol 12 and CP 11. The symbol 12 comprises N samples. The CP 11 consists simply of copying the last L samples (portion 13 of FIG. 1) from each symbol and appending them in the same order to the front of the symbol. In this regard, the subcarriers used in an OFDM system and the length of the CP can be dynamically varied according to particular channel conditions. In particular, as shown in Table One of FIG. 2, a DVB-T signal can be transmitted in accordance with any one of eight transmission modes, each transmission mode having a different number (N) of subcarriers and CP length ratio (α), i.e., the ratio of the CP length over the symbol length N. For example, in transmission mode 1, the number of subcarriers, N, is equal to 2048 and the length ratio of the CP is 1/4, i.e., the CP consists of L=1/4(2048)=512 samples.

### SUMMARY OF THE INVENTION

Although a DVB-T signal may be transmitted in accordance with any one of eight transmission modes, we have observed that it is still possible to efficiently detect the presence and transmission mode of a DVB-T signal without having to resort to a complex apparatus or algorithm. In particular, and in accordance with the principles of the invention, a receiver provides at least two data segments representative of a received signal; and determines if the received signal is a type of signal as a function of at least a plurality of transmission modes associated with the type of signal and the at least two data segments representative of the received signal.

In an illustrative embodiment of the invention, the receiver is a Wireless Regional Area Network (WRAN) endpoint, and the type of signal is a DVB-T signal having eight possible transmission modes. The WRAN endpoint processes a received signal to provide two data segments and determines an average of the autocorrelation of the two data segments at each one of the eight transmission modes. The WRAN endpoint then determines if a DVB-T signal is present as a function of the largest average autocorrelation value. For example, the WRAN endpoint compares the largest average autocorrelation value to a threshold value. If the largest average autocorrelation value is greater than the threshold value, then the received signal is a DVB-T signal. Note that the inventive concept of this invention can also be applied to DVB-H signals.

In accordance with a feature of the invention, the WRAN endpoint also determines the transmission mode of the received signal as a function of the largest average autocorrelation value.

In view of the above, and as will be apparent from reading the detailed description, other embodiments and features are also possible and fall within the principles of the invention.

### BRIEF DESCRIPTION OF THE DRAWINGS

FIG. 1 shows an OFDM symbol;

FIG. 2 shows Table One, which lists the different possible transmission modes for a DVB-T signal;

FIG. 3 shows an illustrative WRAN system in accordance with the principles of the invention;

FIG. 4 shows an illustrative flow chart in accordance with the principles of the invention for use in the WRAN system of FIG. 3;

FIG. 5 shows another illustrative flow chart in accordance with the principles of the invention;

FIG. 6 shows illustrative data segments in accordance with the principles of the invention;

FIG. 7 shows another illustrative flow chart in accordance with the principles of the invention;

FIGS. 8 and 9 show illustrative signal detectors in accordance with the principles of the invention;

FIG. 10 shows another illustrative flow chart in accordance with the principles of the invention; and

FIG. 11 shows an illustrative transmission mode detector in accordance with the principles of the invention.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternating Lines), SECAM (SEquential Couleur Avec Memoire), ATSC (Advanced Television Systems Committee), and networking, such as IEEE 802.16, 802.11h, etc., is assumed. Further information on DVB-T broadcast signals can be found in, e.g., ETSI EN 300 744 V1.4.1 (2001-01), Digital Video Broadcasting (DVB); Framing structure, channel coding and modulation for digital terrestrial television. Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)) or discrete multitone (DMT), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/TEC 13818-1)) for generating transport bit streams are well-known and not described herein. It should also be noted that the inventive concept may be implemented using conventional programming techniques, which, as such, will not be described herein. Finally, like-numbers on the figures represent similar elements.

As noted earlier, a WRAN system makes use of unused broadcast channels in the spectrum. In this regard, the WRAN system performs “channel sensing” to determine which of these broadcast channels are actually active (or “incumbent”) in the WRAN area in order to determine that portion of the spectrum that is actually available for use by the WRAN system. In this example, it is assumed that each broadcast channel may be associated with a corresponding DVB-T broadcast signal. Although a DVB-T signal may be transmitted in accordance with any one of eight transmission modes, we have observed that it is still possible to efficiently detect the presence and transmission mode of a DVB-T signal without having to resort to a complex apparatus or algorithm. In particular, and in accordance with the principles of the invention, a receiver provides at least two data segments representative of a received signal; and determines if the received signal is a type of signal (e.g., a DVB-T signal) as a function of at least a plurality of transmission modes, associated with the type of signal and the at least two data segments representative of the received signal.

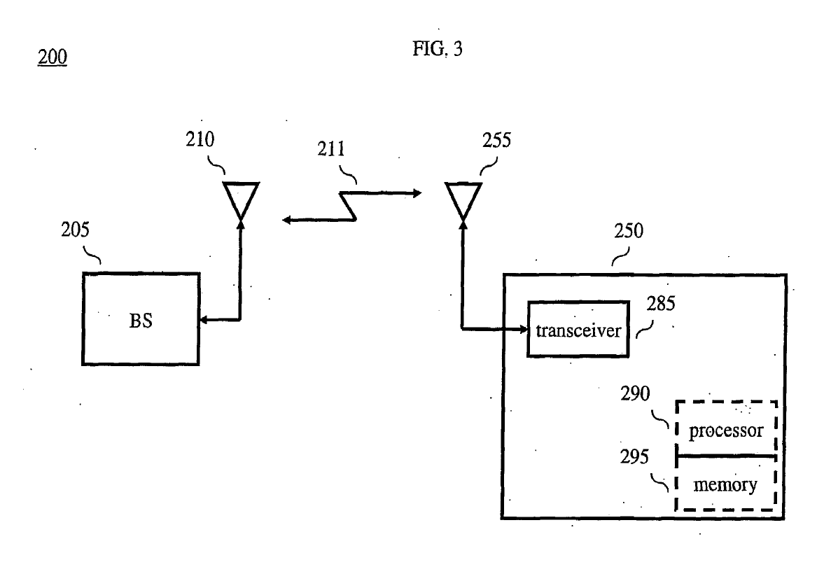

Referring now to FIG. 3. an illustrative Wireless Regional Area Network (WRAN) system 200 incorporating the principles of the invention is shown. WRAN system 200 serves a geographical area (the WRAN area) (not shown in FIG. 3).

WRAN system comprises at least one base station (BS) 205 that communicates with one, or more, customer premise equipment (CPE) 250. The latter may be stationary. Both CPE 250 and BS 205 are representative of wireless endpoints. CPE 250 is a processor-based system and includes one, or more, processors and associated memory as represented by processor 290 and memory 295 shown in the form of dashed boxes in FIG. 3. In this context, computer programs, or software, are stored in memory 295 for execution by processor 290. The latter is representative of one, or more, stored-program control processors and these do not have to be dedicated to the transceiver function, e.g., processor 290 may also control other functions of CPE 250. Memory 295 is representative of any storage device, e.g., TO random-access memory (RAM), read-only memory (ROM), etc.; may be internal and/or external to CPE 250; and is volatile and/or non-volatile as necessary. The physical layer of communication between BS 205 and CPE 250, via antennas 210 and 255, is illustratively OFDM-based via transceiver 285 and is represented by arrows 211. To enter a WRAN network, CPE 250 first attempts to “associate” with BS 205. During this attempt, CPE 250 transmits information, via transceiver 285, on the capability of CPE 250 to BS 205 via a control channel (not shown). The reported capability includes, e.g., minimum and maximum transmission power, and a supported, or available, channel list for transmission and receiving. In this regard, CPE 250 performs “channel sensing” in accordance with the principles of the invention to determine which TV channels are not active in the WRAN area. The resulting available channel list for use in WRAN communications is then provided to BS 205. The latter uses the above-described reported information to decide whether to allow CPE 250 to associate with BS 205.

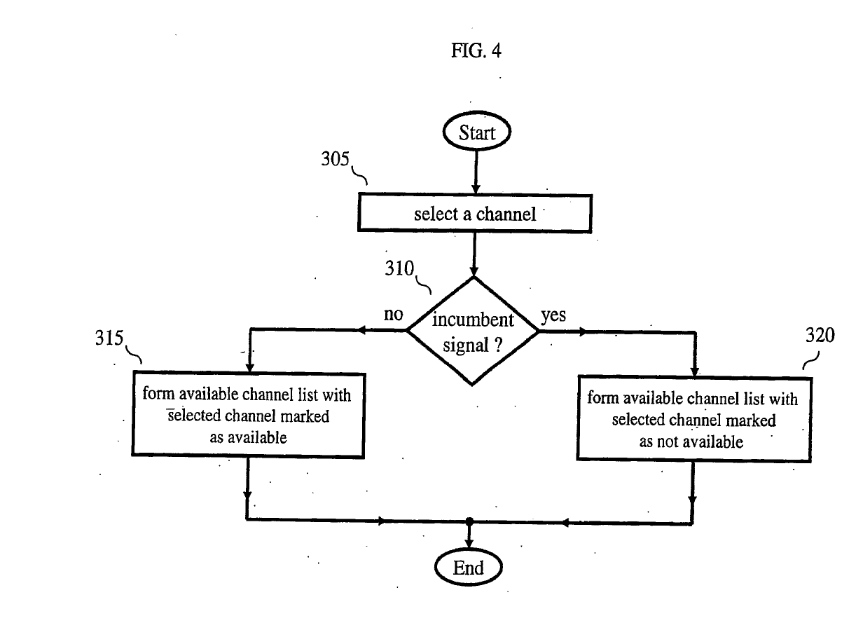

Turning now to FIG. 4, an illustrative flow chart for use in performing channel sensing in accordance with the principles of the invention is shown. The flow chart of FIG. 4 can be performed by CPE 250 over all of the channels, or only over those channels that CPE 250 has selected for possible use. Preferably, in order to detect incumbent signals in a channel, CPE 250 should cease transmission in that channel during the detection period. In this regard, BS 205 may schedule a quiet interval by sending a control message (not shown) to CPE 250. In step 305, CPE 250 selects a channel. In this example, the channel is assumed to be one of a number of broadcast channels present in the WRAN area. In step 310, CPE 250 scans the selected channel to check for the existence of an incumbent signal. In particular, CPE 250 determines if the received signal is a type of signal (e.g., a DVB-T signal) as a function of at least a plurality of transmission modes associated with the type of signal and at least two data segments representative of the received signal (described further below). If no incumbent signal has been detected, then, in step 315, CPE 250 indicates the selected channel as available for use by the WRAN system on an available channel list (also referred to as a frequency usage map). However, if an incumbent signal is detected, then, in step 320, CPE 250 marks the selected channel as not available for use by the WRAN system. As used herein, a frequency usage map is simply a data structure stored in, e.g., memory 295 of FIG. 3, that identifies one, or more, channels, and parts thereof, as available or not for use in the WRAN system of FIG. 3. It should be noted that marking a channel as available or not can be done in any number of ways. For example, the available channel list may only list those channel that are available, thus effectively indicating other channels as not available. Similarly, the available channel list may only indicate those channels that are not available, thus effectively indicating, other channels as available.

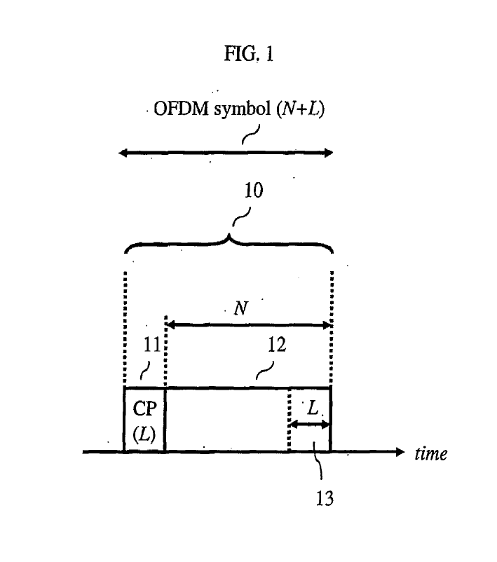

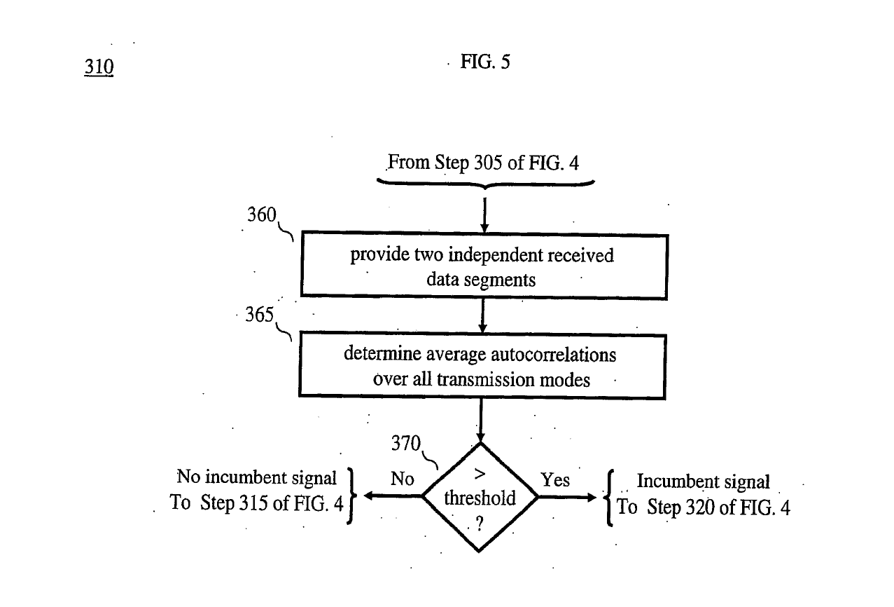

An illustrative flow chart for performing step 310 of FIG. 4 is shown in FIG. 5. A DVB-T signal is a form of cyclostationary signal that is affected by timing jitter and frequency distortion. As can be observed from FIG. 1, the symbol length of an OFDM symbol, M, is:

M=N+L; (1)

where N is the number of subcarriers and L is the length of the cyclic prefix (CP). In particular, let Mᵢ; i=1, 2, . . . , 8; denote the eight possible symbol lengths of the corresponding eight transmission modes for a DVB-T signal and further denote cᵣⁱ[n,τ] as the autocorrelation function of the received signal, which assumes that the OFDM symbol length is Mᵢ. Then, an estimate of cᵣⁱ[n,τ], i.e., ĉᵣⁱ[n,τ], can be computed in the receiver by:

$${\hat{c}}_{r}^{i} [ n , τ ] = \frac{1}{{A}_{i}} {\sum }_{u = 0}^{{A}_{i} - 1} r [ n + τ + {uM}_{i} ] {r}^{*} [ n + {uM}_{i} ] , \qquad ( 2 )$$

for n=0, 1, . . . , Mᵢ−1. Equation (2) represents an autocorrelation of a received signal r[m], where r[m] is the samples of the received OFDM signal at the different sample index m. In equation (2), i is the transmission mode index, i=1, . . . , 8, and r*[m] represents the complex conjugate of the received samples. In addition, Aᵢ is the number of the OFDM symbols used to compute the estimated sample autocorrelation for a corresponding transmission mode, i. Now, the following parameter, Tᵢ, is defined:

$${T}_{i} = \frac{1}{{M}_{i}} {\sum }_{n = 0}^{{M}_{i} - 1} {\hat{c}}_{{r}_{1}}^{i} [ n , τ ] {{\hat{c}}_{{r}_{2}}^{i} [ n , τ ]}^{*} , \qquad ( 3 )$$

where ĉᵣ_{₁}ⁱ[n,τ] and ĉᵣ_{₂}ⁱ[n,τ] are two estimated sample autocorrelation functions from two independent received data segments (r₁ and r₂). The function ĉᵣ_{₁}ⁱ[n,τ] is defined as (2) and the function ĉᵣ_{₂}ⁱ[n,τ] is defined as

$${\hat{c}}_{r}^{i} [ n , τ ] = \frac{1}{{A}_{i}} {\sum }_{u = 0}^{{A}_{i} - 1} r [ n + P + τ + {uM}_{i} ] {r}^{*} [ n + P + {uM}_{i} ] \qquad ( 3 a )$$

where P is a multiple of Mᵢ which is large enough to guarantee ĉᵣ_{₁}ⁱ[n,τ] and, ĉᵣ_{₂}ⁱ[n,τ] are estimated by two independent data segments. In other words, the receiver determines an average of the autocorrelation over the length of ah OFDM symbol. It should be noted that the number of samples in the above equation happens to equal the length of the OFDM symbol, but more samples can be used. From equation (3), when Mᵢ represents the correct transmission mode the value for equation (3) is larger as compared to the values for equation (3) in the other transmission modes. Therefore, and in accordance with the principles of the invention, the following test statistic is used for performing spectrum sensing for a DVB-T signal:

$${T}_{CS} = {max}_{i} \vert {T}_{i} \vert \qquad ( 4 )$$

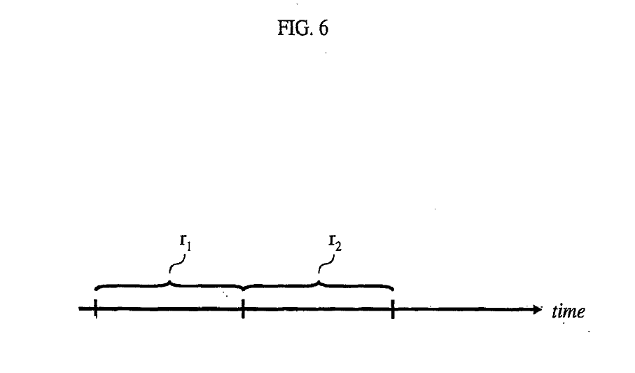

Thus, a receiver provides at least two data segments representative of a received signal; and determines if the received signal is a type of signal (e.g., a DVB-T signal) as a function of at least a plurality of transmission modes associated with the type of signal and the at least two data segments representative of the received signal. Turning now in more detail to the flow chart of FIG. 5, in step 360, CPE 250 provides two independent received data segments, r₁ and r₂ from the received signal on the selected channel. This is illustratively shown in FIG. 6. Although FIG. 6 illustrates that the received data segments, r₁ and r₂, have the same time duration and are contiguous, the inventive concept is not so limited. Returning to FIG. 5, in step 365, CPE 250 evaluates equation (3) across all eight DVB-T transmission modes for the two received data segments. In step 370, CPE 250 determines the maximum value (equation (4)), i.e., T_{CS}, and compares the value of T_{CS} to a threshold value, which may be determined experimentally. If the value of T_{CS} is greater than the threshold value, then it is assumed that a DVB-T broadcast signal is present. However, if the value of T_{CS} is not greater than the threshold value, then it is assumed that a DVB-T broadcast signal is not present.

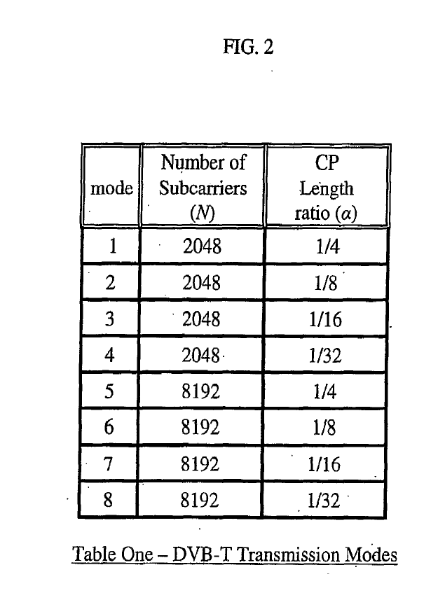

Although not necessary to the inventive concept, it should be noted that calculations can be further simplified in light of the following observation. Referring briefly back to Table One of FIG. 2, it should be noted that those transmission modes having 2048 subcarriers (transmission modes 1, 2, 3 and 4) have smaller size OFDM symbols than for those transmission modes having 8192 subcarriers (transmission modes 5, 6, 7 and 8). As such, it should also be noted that during a given processing interval more OFDM symbols are processed for a transmission mode having 2048 subcarriers than for a transmission mode having 8192 subcarriers. In this regard, and in order to further simplify calculations in the above equations, the number of OFDM symbols chosen for Aᵢ when the transmission mode has 2048 subcarriers (for i=1, 2, 3 and 4) can be twice, or even four times, the number of symbols chosen for Aᵢ when the transmission mode has 8192 subcarriers (for i=5, 6, 7 and 8).

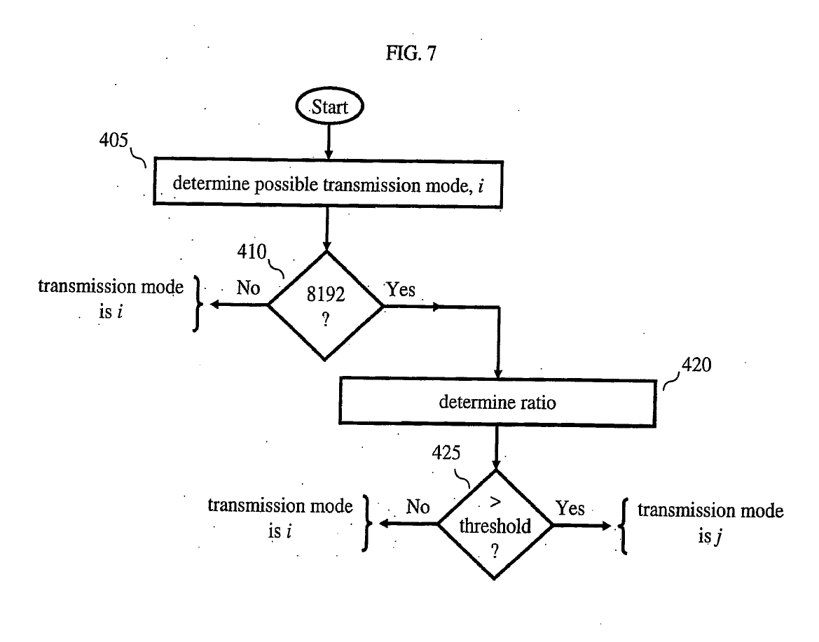

Besides the application of the inventive concept to spectrum sensing, the inventive concept is also applicable to determining the transmission mode of the received DVB-T signal. For example, the value of/associated with T_{CS} can be used to indicate the mode of transmission for the detected DVB-T signal. However, it should be noted that if a signal is periodic in P it is also periodic in 4P. For example, if the transmission mode is 2048 subcarriers with a CP length ratio of 1/4, there will be two cᵣⁱ[n,τ] that are periodic. One is the transmission mode having 2048 subcarriers with a CP length ratio of 1/4 and the other is the transmission mode having 8192 subcarriers with a CP length ratio of 1/4. Consequently, the associated values of Tᵢ from equation (3) may be close together for periodic transmission modes. In addition, for these periodic transmission modes, the value of |Tᵢ| for the transmission mode having 8192 subcarriers may be larger even though the actual transmission mode has 2048 subcarriers. As such, the flow chart of FIG. 7 represents an illustrative method for transmission mode detection in accordance with the principles of the invention. In step 405, CPU 250 determines the value of i associated with T_{CS} (step 370 of FIG. 5). This value of i represents a possible transmission mode for the detected DVB-T signal. In step 410, CPU 250 determines if the possible transmission mode is one of the transmission modes having 8192 subcarriers (e.g., i values of 5, 6, 7 and 8 from Table One of FIG. 2). If the possible transmission mode has 2048 subcarriers (e.g., i values of 1, 2, 3 and 4 from Table One of FIG. 2), then the value of i is used to determine the actual transmission mode. However, if the possible transmission mode has 8192 carriers, then the following, ratio, or comparison, is further determined in step 420:

$$D = \frac{\vert {T}_{j} \vert}{{T}_{CS}} , \qquad ( 5 )$$

where, Tⱼ represents that value of Tᵢ for the corresponding periodic transmission mode having 2048 subcarriers. For example, if the possible transmission mode is i=6, then j=2. In step 425, CPU 250 determines if the value of the ratio is greater than a threshold, e.g., 0.5. If the value of the ratio is not greater than 0.5, then the value of i is used to determine the actual transmission mode (which will have 8192 subcarriers). However, if the value of the ratio is greater than 0.5, then the value of j is used to determine the actual transmission mode (which will have 2048 subcarriers). Thus, the WRAN receiver also determines the mode of the received signal as a function of the largest average autocorrelation value (T_{CS}).

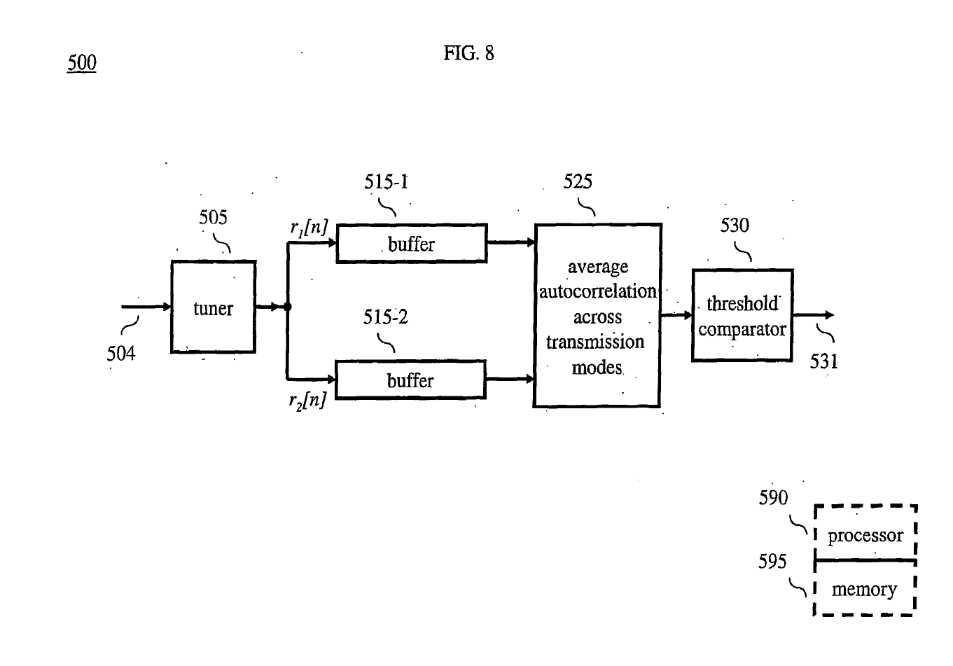

Turning briefly to FIG. 8, an illustrative portion of a receiver 500 for use in CPE 250 is shown (e.g., as a part of transceiver 285). Only that portion of receiver 500 relevant to the inventive concept is shown. The elements shown in FIG. 8 generally correspond to the description of the steps for the flow chart of FIG. 5. As such, the elements shown in FIG. 8 can be implemented in hardware, software, or as a combination of hardware and software. In this regard, receiver 500 is a processor-based system and includes one, or more, processors and associated memory as represented by processor 590 and memory 595 shown in the form of dashed boxes in FIG. 8. It should be noted that processor 590 and memory 595 may be in addition to, or the same as, processor 290 and memory 295 of FIG. 3. Receiver 500 comprises tuner 505, at least two buffers as represented by buffer 515-1 and buffer 515-2, element 525 for computing an average autocorrelation across transmission modes and threshold comparator 530. For simplicity, some elements are not shown in FIG. 8, such as an automatic gain control (AGC) element, an analog-to-digital converter (ADC) if the processing is in the digital domain, and additional filtering. Other than the inventive concept, these elements would be readily apparent to one skilled in the art. Further, those skilled in the art would recognize that some of the processing may involve complex signal paths as necessary.

In the context of the above-described flow charts, for each selected channel (selected via tuner 505) a received signal 504 may be present. Buffer 515-1 stores one data segment of the received signal, r₁[n], and buffer 515-2 stores another data segment of the received signal, r₂[n]. As described above, these received data segments are independent (also see the earlier-described FIG. 6). Element 525 computes an average autocorrelation across transmission modes in accordance with equation (3), above. Threshold comparator 530 compares the largest value for Tᵢ, i.e., T_{CS}, against a threshold value to determine if a type of signal is present and provides the results via signal 531.

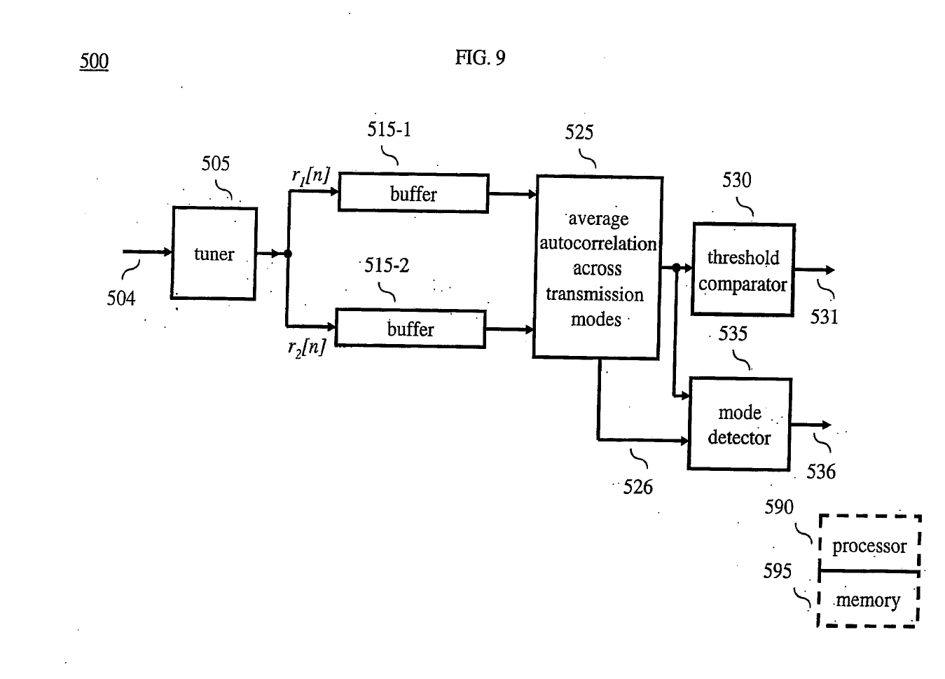

With regard to the above-mentioned transmission mode detection, the apparatus shown in FIG. 8 can be further modified as shown in FIG. 9. In FIG. 9, transmission mode detector element 535 has been added to further process the value of T_{CS} in accordance with the flow chart of FIG. 7. As such, signal 526 provides the Tᵢ values for the other transmission modes for forming the ratio represented by equation (5). The resultant transmission mode is provided via signal 536.

Although the above-described method and apparatus of FIGS. 7 and 9 can be used to determine the transmission mode of a received OFDM-based signal, it is also possible to use the cyclic prefix of an OFDM symbol for determining the transmission mode. For example, in the context of a DVB-T transmission, the following CP correlation function is defined across the eight transmission modes:

$${R}_{i} [ n ] = \frac{1}{{A}_{i} {L}_{i}} {\sum }_{u = 0}^{{A}_{i} - 1} {\sum }_{m = 0}^{{L}_{i} - 1} r [ n + m + {N}_{i} + {uM}_{i} ] {r}^{*} [ n + m + {uM}_{i} ] , \qquad ( 6 )$$

where, again, Aᵢ, is the number of the OFDM symbols accumulated for correlation and n=0, 1, . . . , Mᵢ−1. In addition, Lᵢ, is the length of the CP for the i^{th} transmission mode, Nᵢ is the number of subcarriers for the i^{th} transmission mode and Mᵢ is the OFDM symbol length for the i^{th} transmission mode. In other words, equation (6) averages an autocorrelation over the length of the cyclic prefix for each transmission mode. As before, the calculations can be simplified, e.g., by choosing the number of OFDM symbols for Aᵢ when the transmission mode has 2048 subcarriers (for i=1, 2, 3 and 4) to be twice, or even four times, the number of symbols chosen for Aᵢ when the transmission mode has 8192 subcarriers (for i=5, 6, 7 and 8). It can be observed from equation (6) that the absolute value of Rᵢ[n] is maximum for the correct transmission mode. Thus, the test statistic for use in determining the transmission mode of an OFDM-based signal from the CP is that value of i for which |Rᵢ[n]| has the maximum value. This maximum value is referred to herein as T_{CP}, i.e.,

$${T}_{CP} = {max}_{i} {max}_{0 \leq n \leq {M}_{i} - 1} \vert {R}_{i} [ n ] \vert . \qquad ( 7 )$$

In other words, the determined transmission mode, i, is:

$$i = arg {max}_{i} {max}_{0 \leq n \leq {M}_{i} - 1} \vert {R}_{i} [ n ] \vert . \qquad ( 8 )$$

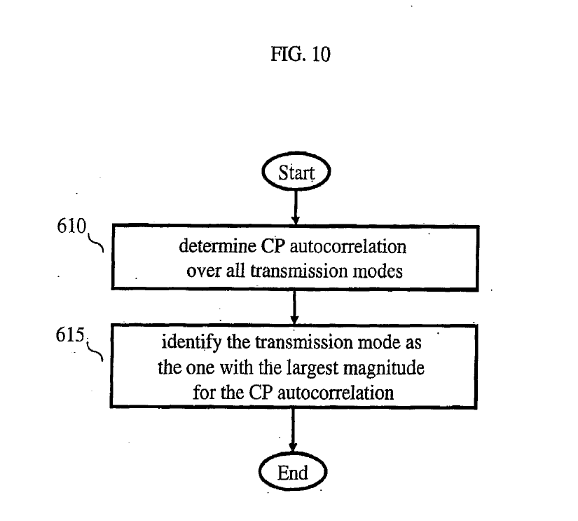

As illustrative flow chart for use in determining a transmission mode from the cyclic prefix is shown in FIG. 10. In step 610, CPE 250 evaluates equation (6) across all eight DVB-T transmission modes for a received signal. In step 615, CPE 250 determines the maximum value (equation (7)), i.e., T_{CP}, and identifies the transmission mode of the DVB-T signal (equation (8).

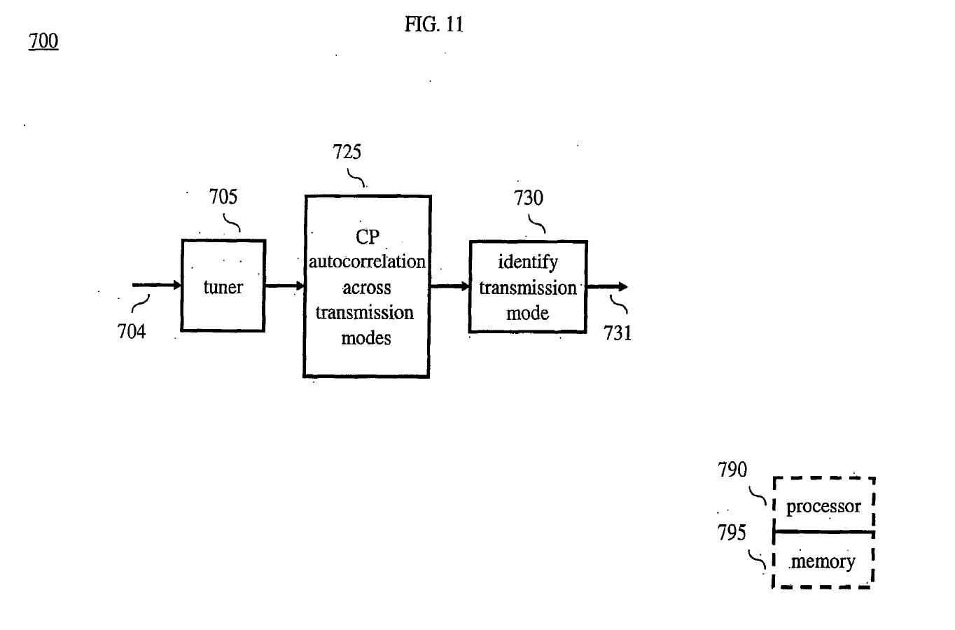

Turning briefly to FIG. 11, an illustrative portion of a receiver 700 for use in CPE 250 is shown (e.g., as a part of transceiver 285). Only that portion of receiver 700 relevant to the inventive concept is shown. The elements shown in FIG. 11 generally correspond to the description of the steps for the flow chart of FIG. 10. As such, the elements shown in FIG. 11 can be implemented in hardware, software, or as a combination of hardware and software. In this regard, receiver 700 is a processor-based system and includes one, or more, processors and associated memory as represented by processor 790 and memory 795 shown in the form of dashed boxes in FIG. 11. It should be noted that processor 790 and memory 795 may be in addition to, or the same as, processor 290 and memory 295 of FIG. 3. Receiver 700 comprises tuner 705, element 725 for computing a CP autocorrelation across transmission modes and element 730 for identifying the transmission mode associated with the largest CP autocorrelation. For simplicity, some elements are not shown in FIG. 11, such as an automatic gain control (AGC) element, an analog-to-digital converter (ADC) if the processing is in the digital domain, and additional filtering. Other than the inventive concept, these elements would be readily apparent to one skilled in the art. Further, those skilled in the art would recognize that some of the processing may involve complex signal paths as necessary.

In the context of the flow chart of FIG. 10, for each selected channel (selected via tuner 705) a received signal 704 may be present. Element 725 computes a CP autocorrelation across transmission modes in accordance with equation (6), above, from the received signal. Finally, element 730 identifies the transmission mode associated with the largest CP autocorrelation in accordance with equations (7) and (8) and provides the results via signal 731.

As described above, it is possible to detect the presence of DVB-T signals in low signal-to-noise environments with high confidence using cyclostationary properties of the DVB-T signal. However, the inventive concept is not so limited and can also be applied to detecting any signal that has cyclostationary properties. Further, the inventive concept can be combined with other techniques for detecting the presence of a signal. It should also be noted that although the inventive concept was described in the context of CPE 250 of FIG. 3, the invention is not so limited and also applies to, e.g., a receiver of BS 205 that may perform channel sensing. Further, the inventive concept is not restricted to a WRAN system and may be applied to any receiver that performs channel, or spectrum, sensing.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements (e.g., of FIGS. 8, 9 and 11) may be implemented in a stored-program-controlled processor, e.g., a digital signal processor, which executes associated software, e.g., corresponding to one, or more, of the steps shown in, e.g., FIGS. 4, 5, 7 and 10. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a receiver, the method comprising:
providing at least two data segments representative of a received signal on a selected channel; and
determining if the received signal is a type of signal as a function of at least a plurality of transmission modes associated with the type of signal and the at least two data segments representative of the received signal.

2. The method of claim 1, wherein the at least two data segments are not contiguous.

3. The method of claim 1, wherein a time duration of at least one of the data segments is different.

4. The method of claim 1, wherein the determining step includes the step of
determining the transmission mode of the received signal.

5. The method of claim 1, wherein the determining step includes the steps of:
determining for each one of the plurality of transmission modes an average autocorrelation value for the at least two data segments; and
determining that a type of signal is present as a function of the largest average autocorrelation value.

6. The method of claim 5, wherein the determining for each one step determines a parameter Tᵢ for a transmission mode for the at least two data segments, where:
$${T}_{i} = \frac{1}{{M}_{i}} {\sum }_{n = 0}^{{M}_{i} - 1} {\hat{c}}_{{r}_{1}}^{i} [ n , τ ] {{\hat{c}}_{{r}_{2}}^{i} [ n , τ ]}^{*}$$

7. The method of claim 6, wherein the determining that a type of signal is present includes the step of:
comparing
$${T}_{i} = \frac{1}{{M}_{i}} {\sum }_{n = 0}^{{M}_{i} - 1} {\hat{c}}_{{r}_{1}}^{i} [ n , τ ] {{\hat{c}}_{{r}_{2}}^{i} [ n , τ ]}^{*} ; and$$
to a threshold value.

8. The method of claim 5, wherein the determining that a type of signal is present includes the step of:
comparing the largest average autocorrelation value to a threshold value.

9. The method of claim 1, wherein the determining step includes the steps of:
determining for each one of the plurality of transmission modes an average autocorrelation value for the at least two data segments; and
determining the transmission mode of the received signal as a function of the one of the plurality of transmission modes associated with the largest average autocorrelation value.

10. The method of claim 9, wherein at least some of the plurality of transmission modes are periodically related and the determining the transmission mode of the received signal step includes the steps of:
selecting as the transmission mode of the received signal either the transmission mode associated with the largest average autocorrelation value of the periodically related transmission mode; wherein the selection is performed as a function of a comparison between that average autocorrelation value associated with the periodically related transmission mode and the largest average autocorrelation value.

11. The method of claim 10, wherein the comparison is a ratio and the selecting step includes the steps of:
if the ratio is greater than a value, selecting the periodically related transmission mode as the transmission mode of the received signal; and
otherwise, selecting the one of the plurality of transmission modes associated with the largest average autocorrelation value as the transmission mode of the received signal.

12. The method of claim 1, wherein the type of signal is an orthogonal frequency division multiplexed (OFDM) signal.

13. The method of claim 12, wherein the type of signal is a Digital Video Broadcasting (DVB) signal.

14. The method of claim 1, further comprising the step of:
marking an available channel list to indicate that the selected channel is available for use if the type of signal is not present.

15. Apparatus comprising:
a tuner for providing a signal from a selected channel; and
a processor for use in determining if the signal is a type of signal as a function of at least a plurality of transmission modes associated with the type of signal and at least two data segments representative of the signal.

16. The apparatus of claim 15, further comprising:
a plurality of buffers for storing the at least two data segments representative of the signal.

17. The apparatus of claim 15, wherein the at least two data segments are not contiguous.

18. The apparatus of claim 15, wherein a time duration of at least one of the data segments is different.

19. The apparatus of claim 15, wherein the processor determines a transmission mode of the signal.

20. The apparatus of claim 15, wherein the processor (a) determines for each one of the plurality of transmission modes an average autocorrelation value for the at least two data segments, and (b) determines that a type of signal is present as a function of the largest average autocorrelation value.

21. The apparatus of claim 20, wherein the processor determines that a type of signal is present by comparing the largest average autocorrelation value to a threshold value.

22. The apparatus of claim 21, wherein the processor determines a transmission mode of the signal as a function of the one of the plurality of transmission modes associated with the largest average autocorrelation value.

23. The apparatus of claim 15, wherein the processor (a) determines a parameter Tᵢ for each transmission mode for the at least two data segments, where:
$${max}_{i} \vert {T}_{i} \vert$$
(b) determines that a type of signal is present by comparing
$${max}_{i} \vert {T}_{i} \vert$$
to a threshold value.

24. The apparatus of claim 15, wherein the type of signal is an orthogonal frequency division multiplexed (OFDM) signal.

25. The apparatus of claim 24, wherein the type of signal is a Digital Video Broadcasting (DVB) signal.

26. The apparatus of claim 15, further comprising:
a memory for storing an available channel list to indicate that the selected channel is available for use if the type of signal is not present.
